(19) United States
(12) Patent Application Publication
(10) Pub. No.: US 2024/0142619 A1
(43) Pub. Date: May 2, 2024

(54) CONTEMPORANEOUS FIRING SCHEME FOR ACOUSTIC INSPECTION

(71) Applicant: EVIDENT CANADA, INC., Quebec (CA)

(72) Inventors: Benoit Lepage, L’Ancienne-Lorette (CA); Jinchi Zhang, Quebec (CA)

(21) Appl. No.: 18/555,764

(22) PCT Filed: Apr. 28, 2022
(86) PCT No.: PCT/CA2022/050649

§ 371 Date: Oct. 17, 2023

Related U.S. Application Data
(60) Provisional application No. 63/201,468, filed on Apr. 30, 2021.

(51) Int. Cl. G01S 15/89; G01S 7/52; G01S 15/10

(52) U.S. Cl. CPC G01S 15/8925; G01S 7/52022; G01S 15/102; G01S 15/8918

(57) ABSTRACT

Acoustic evaluation of a target can be performed using an array of electro-acoustic transducers. For example, a technique for such evaluation can include generating pulses for transmission by respective ones of a plurality of electro-acoustic transducers in a transducer array to contemporaneously establish respective acoustic beams corresponding to at least two different acoustic beam steering directions for an acquisition, the pulses comprising at least a first sequence having pulses of defining a profile having a first polarity, the first sequence corresponding to a first beam steering direction (e.g., angle or spatial beam direction), and a second sequence having pulses defining a profile having a second polarity opposite the first polarity, the second sequence corresponding to a second beam steering direction. In response to transmission of the pulses, respective acoustic echo signals can be received and aggregated to form an image of a region of interest on or within the target.

### CLAIM OF PRIORITY

This patent application is a U.S. National Stage filing under 37 U.S.C. § 371 from Lepage et al., International Application No. PCT/CA2022/050649, titled “CONTEMPORANEOUS FIRING SCHEME FOR ACOUSTIC INSPECTION,” filed on Apr. 28, 2022 (Attorney Docket No. 6409.194WO1), which claims the benefit of priority of Lepage et al., U.S. Provisional Patent Application Ser. No. 63/201,468, titled “CONTEMPORANEOUS FIRING SCHEME FOR ACOUSTIC INSPECTION,” filed on Apr. 30, 2021 (Attorney Docket No. 6409.194PRV), which are hereby incorporated by reference herein in their entireties.

### FIELD OF THE DISCLOSURE

This document pertains generally, but not by way of limitation, to non-destructive evaluation, and more particularly, to apparatus and techniques for providing acoustic inspection using multiple contemporaneously-transmitted acoustic beams, such as established using a one-dimensional or two-dimensional transducer array.

### BACKGROUND

Various inspection techniques can be used to image or otherwise analyze structures without damaging such structures. For example, one or more of x-ray inspection, eddy current inspection, or acoustic (e.g., ultrasonic) inspection can be used to obtain data for imaging of features on or within a test specimen. For example, acoustic imaging can be performed using an array of ultrasound transducer elements, such as to image a region of interest within a test specimen. Different imaging modes can be used to present received acoustic signals that have been scattered or reflected by structures on or within the test specimen.

For example, an amplitude or “A-scan” representation can include generating a plot or other display of a received ultrasound signal magnitude versus time or depth, such as along a linear beam axis or ray traversing the test specimen. Beamforming can be performed using coherent excitation of ultrasound transducers to provide a desired beam angle and focal location. For example, coherent excitation can include applying specified delay values (or phase shift) to pulses for transmission by individual array elements (or apertures defined thereby) to establish either a desired beam angle and focal location, or both. Alternatively, or in addition, beamforming can be performed in reception such as by summing received acoustic echo signals in manner where signals received from individual array elements are delayed (or phase shifted) to provide one or more of a desired beam angle and focal location.

### SUMMARY OF THE DISCLOSURE

Acoustic testing, such as ultrasound-based inspection, can include focusing or beamforming techniques to aid in construction of data plots or images representing a region of interest within the test specimen. Use of an array of ultrasound transducer elements can include use of a phased-array beamforming approach and can be referred to as Phased Array Ultrasound Testing (PAUT). For example, a delay-and-sum beamforming technique can be used such as including coherently summing time-domain representations of received acoustic signals from respective transducer elements or apertures.

The inventors have recognized, among other things, that use of multiple (e.g., two or more) contemporaneously-established acoustic beams can enhance acoustic inspection throughput, such as by allowing acoustic interrogation (e.g., scanning) of a greater spatial extent for each acquisition as compared to using a single beam approach across multiple acquisitions. However, use of such contemporaneously-established beams (such as can be referred to as “simultaneous firing”) can present various challenges. For example, the acoustic pressure fields corresponding to each beam may overlap at or near a central axis or central region of a transmitting acoustic probe array. Such overlap may occur when firing angles are close to each other, or as a count of firing angles increases. An acoustic pressure field may also include undesired off-axis features such as side-lobes.

In one approach, a time-reversal technique can be used for transmit pulse synthesis, such as established as a sequence of square pulses having the same polarity. Simulation shows that temporal and spatial overlap of pulses having the same polarity can result in fired beams that include acoustic components that interfere with each other in an unwanted manner. Generally, contemporaneously fired beams may be ill-defined or otherwise not well-controlled in direction or spatial extent if synthesized using a technique where unmodified individual transmit excitation pulse sequences for each beam direction are merely superimposed on each other without adjustment, and where each of the pulses have the same polarity.

To address such challenges, the present inventors have also recognized that establishing pulse profiles for respective contemporaneously-generated beams in manner having alternating or otherwise controlled pulse polarities can counteract inter-beam interference, while using an approach similar to a time-reversal approach but including modification or adjustment of the pulse sequences. For example, polarities of respective pulses used in one sequence can be inverted with respect to respective polarities in a sequence used for generating a spatially adjacent beam. Use of such “alternating” polarities can result in reduction or cancelation of pulse amplitudes in a manner that relaxes a count of required amplitude levels or a dynamic range of a transmit driver, or both. Such an approach can provide contemporaneously generated beams that each more closely resemble an acoustic pressure field profile corresponding to a reference profile comprising single beam. The approach described herein can also facilitate use of simpler drive circuitry versus other approaches because the pulse amplitudes are lower by comparison, and fewer amplitude levels can be used.

In an example, acoustic evaluation of a target can be performed using an array of electro-acoustic transducers, such as a one-dimensional (e.g., linear) or two-dimensional (e.g., matrix) array. For example, a technique for such evaluation can include generating pulses for transmission by respective ones of a plurality of electro-acoustic transducers in a transducer array to contemporaneously establish respective acoustic beams corresponding to at least two different acoustic beam steering directions for an acquisition, the pulses comprising at least a first sequence having pulses of defining a profile having a first polarity, the first sequence corresponding to a first beam steering direction, and a second sequence having pulses defining a profile having a second polarity opposite the first polarity, the second sequence corresponding to a second beam steering direction. In response to transmission of the pulses, respective acoustic echo signals can be received and aggregated to form an image of a region of interest on or within the target. For example, the first sequence and the second sequence can define respective pulse sequences for different ones of the plurality of electro-acoustic transducers, the respective pulse sequences comprising a sum of contributions from the first sequence and the second sequence corresponding to a respective one of the plurality of electro-acoustic transducers. The generation of pulses for transmission can include suppressing formation of a sidelobe or beam in a direction normal to a surface of the target.

As an illustrative example, a system for acoustic evaluation of a target can include an analog front end comprising transmit and receive circuitry coupled to a plurality of electro-acoustic transducer elements, a processor circuit communicatively coupled with the analog front end, and a memory circuit comprising instructions that, when executed by the processor circuit, cause the system to perform the acoustic evaluation, such as to generate pulses for transmission by respective ones of the plurality of electro-acoustic transducers in a transducer array to contemporaneously establish respective acoustic beams corresponding to at least two different acoustic beam steering directions for an acquisition, the pulses comprising at least a first sequence having pulses of defining a profile having a first polarity, the first sequence corresponding to a first beam steering direction, and a second sequence having pulses defining a profile having a second polarity opposite the first polarity, the second sequence corresponding to a second beam steering direction, and in response to transmission of the pulses, receive respective acoustic echo signals and aggregating the received acoustic echo signals to form an image of a region of interest on or within the target.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an acoustic inspection system, such as can be used to perform at least a portion one or more techniques as shown and described herein.

FIG. 2A, FIG. 2B, and FIG. 2C show illustrative examples of simulated single-beam acoustic pressure fields corresponding to different steering angles, such as generated by a linear array driven to provide a single beam direction.

FIG. 2D, FIG. 2E, and FIG. 2F show illustrative examples of pulse timing for respective elements or transmission apertures in the linear array, corresponding to each of the simulated single-beam acoustic pressure fields of FIG. 2A, FIG. 2B, and FIG. 2C.

FIG. 3A and FIG. 3B show illustrative examples of acoustic pressure fields corresponding to different pulse sequences established using a time-reversal approach, illustrating that beam orientations are not well-defined by comparison with the individual steered beams of FIG. 2A, FIG. 2B, and FIG. 2C.

FIG. 3C and FIG. 3D show illustrative examples of pulse timing for respective elements or transmission apertures in the linear array, corresponding to each of the simulated acoustic pressure fields of FIG. 3A and FIG. 3B.

FIG. 4A and FIG. 4B show illustrative examples of acoustic pressure fields corresponding to different pulse sequences established according to the present subject matter where polarities of respective pulses or pulse profiles alternate for adjacent steering angles or beam locations.

FIG. 4C and FIG. 4D show illustrative examples of pulse timing for respective elements or transmission apertures in the linear array, corresponding to each of the simulated acoustic pressure fields of FIG. 4A and FIG. 4B, with arrows indicating alternating polarity pulses corresponding to the respective beams (e.g., where polarities of respective pulses or pulse profiles alternate for adjacent steering angles or beam locations).

FIG. 5A shows an illustrative example of a two-dimensional array representation (e.g., a “matrix probe”), for which a technique similar to the examples of FIG. 4A, FIG. 4B, FIG. 4C, and FIG. 4D can be extended to a two-dimensional array application.

FIG. 5B shows an illustrative example of acoustic beam directions, the acoustic beams extending at least in part radially in a circular arrangement about a central axis of the two-dimensional array, with respective pulse profile polarities indicated by “+” or “−” symbols.

FIG. 6A shows an illustrative example comprising pulse sequences and corresponding amplitudes for each element in a 64-element array, such as a 2D array as shown in FIG. 5A having pulse profiles corresponding to the profile polarities shown illustratively in FIG. 5B.

FIG. 6B shows an illustrative example comprising pulse sequences for an individual transducer element (or transducer aperture), according to the scheme shown in FIG. 6A.

FIG. 7A shows an illustrative example comprising an acoustic pressure field in a section of Z-plane (according to the coordinate system shown illustratively in FIG. 5A), established using the pulse sequence of FIG. 6A (e.g., a first transmit set), showing different acoustic beam directions, the acoustic beams extending at least in part radially in a circular arrangement about a central axis of the two-dimensional array.

FIG. 7B shows an illustrative example comprising an acoustic pressure field in a section of the X-Z plane (according to the coordinate system shown illustratively in FIG. 5A), showing the different acoustic beam directions of FIG. 7A from another perspective.

FIG. 7C shows an illustrative example comprising an acoustic pressure field in a section of Z-plane (according to the coordinate system shown illustratively in FIG. 5A), where acoustic beams are established using a different set of transmit sequences (e.g., a second transmit set), such as to establish another set of acoustic beams located in the “gaps” between the acoustic beams established using the pulse sequence of FIG. 6A and as shown in FIG. 7A.

FIG. 8 illustrates generally a technique, such as a method for operating an acoustic inspection system.

FIG. 9 illustrates a block diagram of an example comprising a machine upon which any one or more of the techniques (e.g., methodologies) discussed herein may be performed.

### DETAILED DESCRIPTION

The present subject matter concerns apparatus and techniques that facilitate high-throughput acoustic inspection, such as by enabling contemporaneous generation of multiple acoustic beams in a contemporaneous manner. Such a scheme can be referred to as “simultaneous firing,” even though respective elements an acoustic array need not all be transmitting literally simultaneously. Contemporaneous generation of multiple beams can include generating sequences of pulses directed to respective acoustic transducers (or corresponding groups of transducers defining respective transmit apertures), to create acoustic signals that, when aggregated with transmissions from each other, result in an acoustic pressure field having two or more coherent acoustic beams extending in different specified directions. The present inventors have recognized, among other things, that for pulse sequences used for contemporaneous transmission (as compared receiving), generated pulses associated with each beam may overlap temporally in the elements around center of a transmitting array, such as when the generated beam angles are close to each other or when there are many beams being generated contemporaneously. The present inventors have also recognized that reduction of distortion due to pulse overlap can help reduce deviation of a respective beam from its reference profile, with the reference profile corresponding to a single (non-contemporaneous) beam being transmitted alone. The examples herein show one-dimensional (e.g., linear) and two-dimensional (e.g., matrix) array implementations and examples of pulse sequences that can be used to provide multiple beam directions contemporaneously.

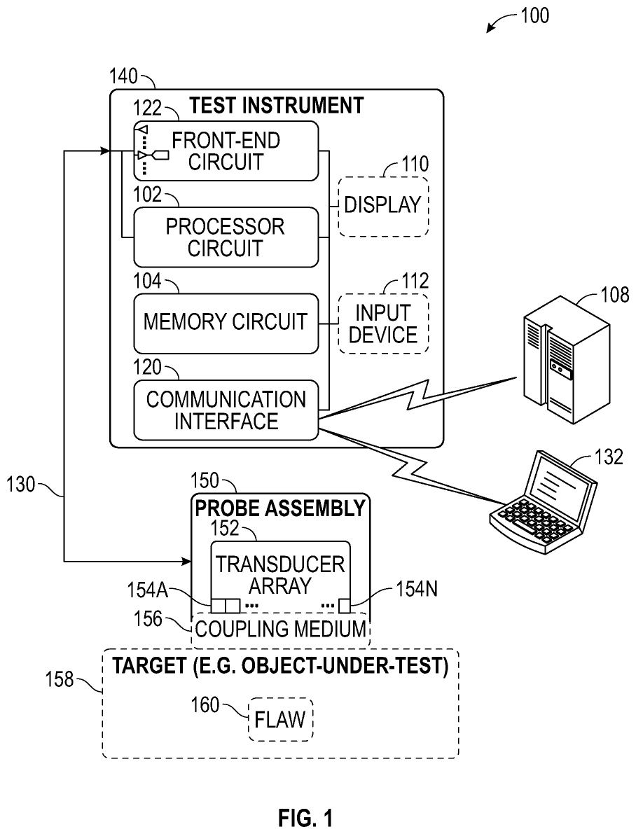

FIG. 1 illustrates generally an example comprising an acoustic inspection system 100, such as can be used to perform at least a portion one or more techniques as shown and described herein. The inspection system 100 can include a test instrument 140, such as a hand-held or portable assembly. The test instrument 140 can be electrically coupled to a probe assembly, such as using a multi-conductor interconnect 130. The probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly 150 configuration can be used, such as to allow a test instrument 140 to be used with various different probe assemblies 150. Generally, the transducer array 152 includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing, or testing can be conducted with an interface between the probe assembly 150 and the target 158 otherwise immersed in a coupling medium.

The test instrument 140 can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification.

While FIG. 1 shows a single probe assembly 150 and a single transducer array 152, other configurations can be used, such as multiple probe assemblies connected to a single test instrument 140, or multiple transducer arrays 152 used with a single or multiple probe assemblies 150 for pitch/catch inspection modes. Similarly, a test protocol can be performed using coordination between multiple test instruments 140, such as in response to an overall test scheme established from a master test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit can be coupled to a memory circuit, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or other representations of such data, for example, can be accomplished using remote facilities communicatively coupled to the test instrument 140. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

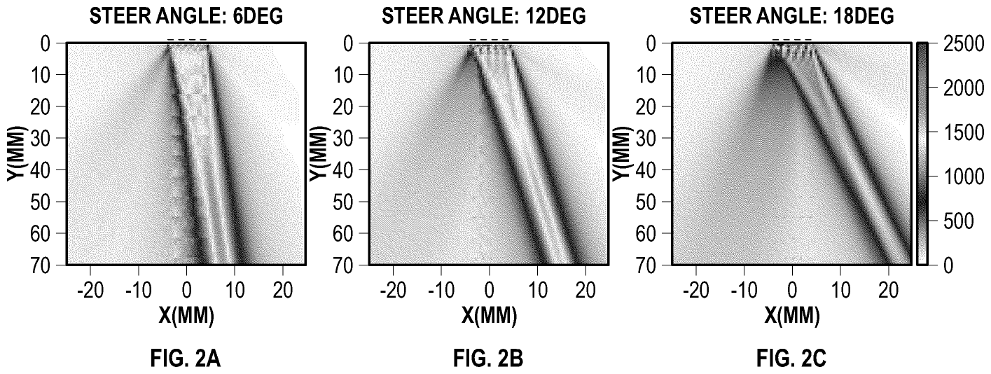

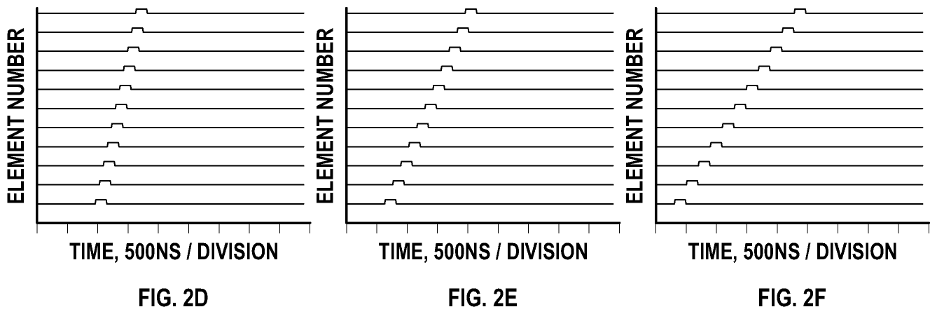

FIG. 2A, FIG. 2B, and FIG. 2C show illustrative examples of simulated single-beam acoustic pressure fields corresponding to different steering angles. FIG. 2A shows a +6-degree steering angle, FIG. 2B shows a +12-degree steering angle, and FIG. 2C shows a +18-degree steering angle. The sound fields of FIG. 2A, FIG. 2B, and FIG. 2B can be generated by a linear array driven to provide a single beam direction. Such examples can be considered “reference” representations corresponding to single-angle or single-direction acoustic beamforming. Single-unit pulse amplitudes are used (e.g., only two pulse amplitude levels, zero units and one unit, are used). Generally, the techniques shown and described herein can be used to provide contemporaneous generation of multiple beams that approximate pressure fields of the corresponding single-beam reference fields. FIG. 2D, FIG. 2E, and FIG. 2F show illustrative examples of pulse timing for respective elements or transmission apertures in the linear array, corresponding to each of the simulated single-beam acoustic pressure fields of FIG. 2A, FIG. 2B, and FIG. 2C.

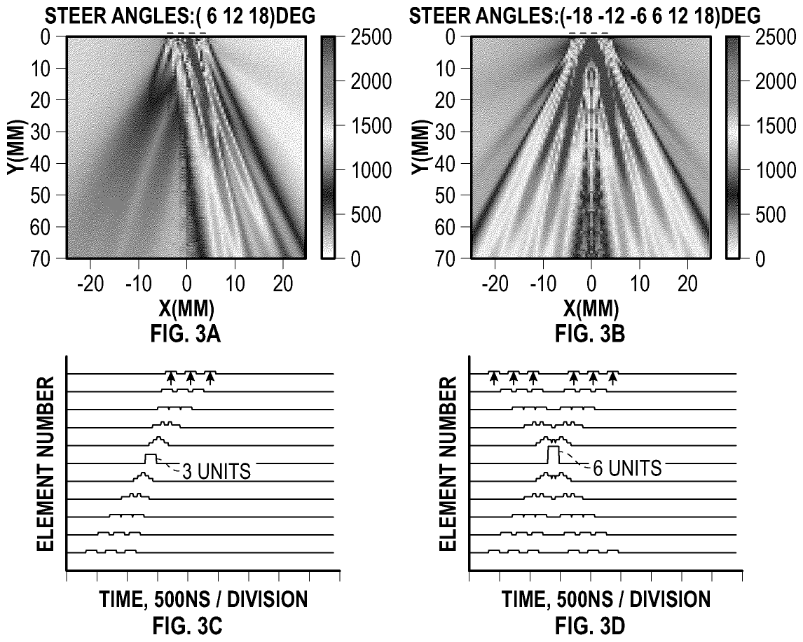

FIG. 3A and FIG. 3B show illustrative examples of acoustic pressure fields corresponding to different pulse sequences established using a time-reversal approach, illustrating that, for the simulated parameters, beam orientations are not well-defined by comparison with the individual steered beams of FIG. 2A, FIG. 2B, and FIG. 2C. FIG. 3C and FIG. 3D show illustrative examples of pulse timing for respective elements or transmission apertures in the linear array, corresponding to each of the simulated acoustic pressure fields of FIG. 3A and FIG. 3B. For example, FIG. 3A shows contemporaneous firing of +6-, +12-, and +18-degree steering angles (combining the individual beams of FIG. 2A, FIG. 2B, and FIG. 2C), with FIG. 3C showing the corresponding pulse timing. FIG. 3B shows contemporaneous firing of −18-, −12-, −6-, +6-, +12-, and +18-degree steering angles (combining the individual beams of FIG. 2A, FIG. 2B, and FIG. 2C and adding their “mirror” angles). FIG. 3D shows corresponding pulse timing to generate the acoustic pressure field of FIG. 3B. The maximum pulse amplitudes used for the scheme shown in FIG. 3C and FIG. 3D are generally equal to a count of different contemporaneously-established beams, such as +3 units for FIG. 3C (corresponding to three beam directions) and +6 units for FIG. 3D (corresponding to six beam directions). As shown by arrows, all pulses are positive-going with respect to a baseline (e.g., all pulses are the same polarity). While the acoustic pressure fields show some directivity, individual beams at 6-, 12-, and 18-degree angles are not well defined with respect to each other, relative to a central axis shown vertical at the zero-millimeter position, as compared to the alternating polarity examples below.

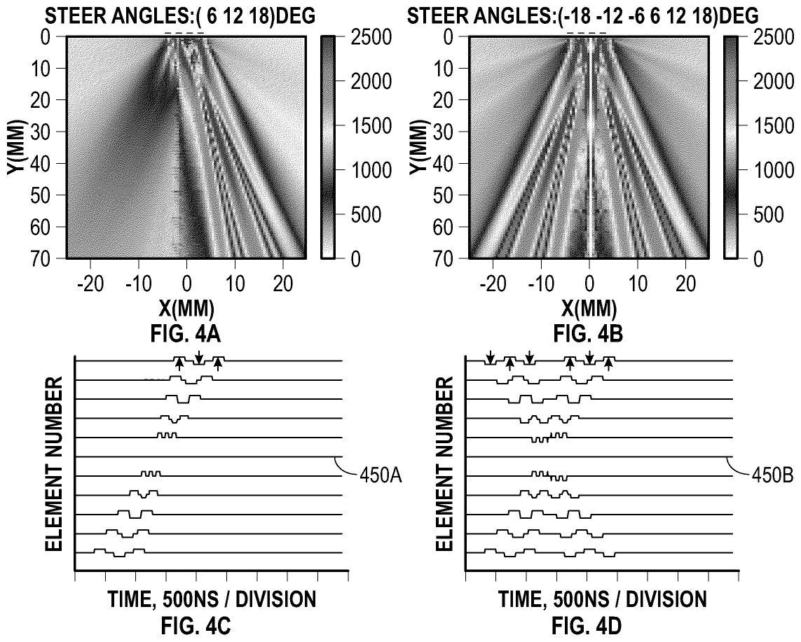

FIG. 4A and FIG. 4B show illustrative examples of acoustic pressure fields corresponding to different pulse sequences established according to the present subject matter where polarities of respective pulses or pulse profiles alternate for adjacent steering angles or beam locations. The acoustic array geometry, and transmission parameters are otherwise the same as the example above in FIG. 3A. FIG. 4C and FIG. 4D show illustrative examples of pulse timing for respective elements or transmission apertures in the linear array, corresponding to each of the simulated acoustic pressure fields of FIG. 4A and FIG. 4B, with arrows indicating alternating polarity pulses corresponding to the respective beams (e.g., where polarities of respective pulses or pulse profiles alternate for adjacent steering angles or beam locations). The various illustrative examples above show sound fields in water simulated using a two-dimensional model. The probe geometry comprises a linear array having 11 elements, using a wavelet corresponding to each pulse, where the wavelet has a 3.5-megahertz (MHz) frequency and 70% bandwidth. The transducer element pitch is 0.75 millimeters, and the focus distance is modeled as infinite for these examples. The approach shown illustratively in FIG. 4C and FIG. 4D can correspond generally to the sequence of FIG. 3C, but by inverting a polarity of the pulses for respective adjacent beam angles. For example, the sequence in FIG. 2D can be combined with an inverted-polarity representation of the sequence of FIG. 2E, along with the sequence of FIG. 2F (e.g., the pulse profiles for a respective element for each beam direction are linearly summed with each other). The resulting sequence is shown illustratively in FIG. 4C. The “mirror” beam angle sequences can be added to provide a six-beam transmission using the pulse sequence shown illustratively in FIG. 4D.

The approach of FIG. 4A, FIG. 4B, FIG. 4C, and FIG. 4D may present challenges, such as at small symmetric angles or a zero-degree angle because the central element may be at zero amplitude such as shown at 450A or at 450B, for example. This challenge can be addressed by using a multi-shot approach, such as including three acquisitions where positive angles are contemporaneously fired during one acquisition, negative angles are contemporaneously fired during another acquisition, and the zero-angle acquisition (e.g., normally incident to a surface of the target) is performed separately using yet another acquisition, if needed for specified spatial or directional coverage depending on the application. Such a sequence of different beam groups is also applicable to examples using a two-dimensional (e.g., matrix) array as discussed below.

In general, the approach of FIG. 4A, FIG. 4B, FIG. 4C, and FIG. 4D can provide improved control of beam orientation for a linear phased-array, leading to a better angular resolution, and as discussed below, a similar scheme is applicable to a two-dimensional (e.g., matrix) array configuration. Drive circuitry can also be simplified versus other approaches because the pulse amplitudes are lower by comparison, and fewer amplitude levels can be used. For example, the approach shown in FIG. 4C and FIG. 4D uses only three levels, comprising +1-unit, −1-unit, and zero units, where a unit corresponds to a specified amplitude value such as a full available output magnitude that can be produced by transmit drive circuitry). Use of a single-unit positive-going or negative-going pulse sequences allows use of the present contemporaneous firing scheme with legacy transmit hardware where multiple positive or negative amplitude levels (other than single-unit) may not be supported.

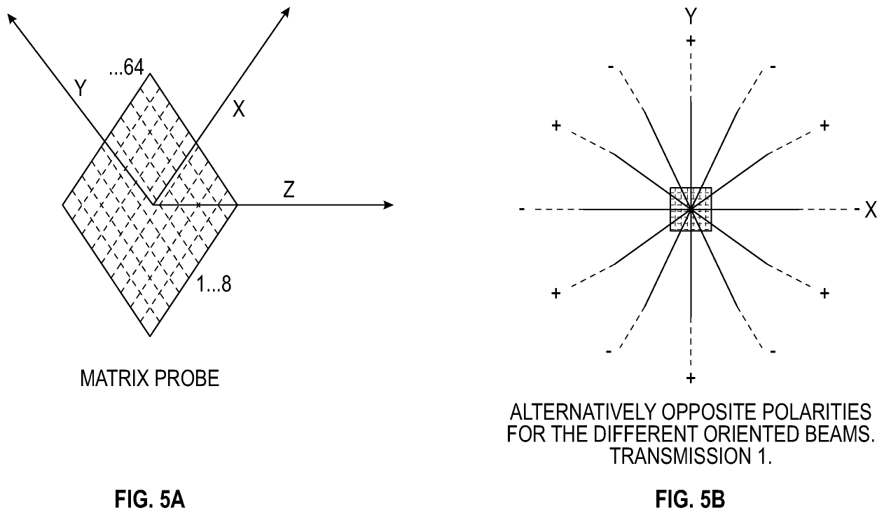

FIG. 5A shows an illustrative example of a two-dimensional array representation (e.g., a “matrix probe”), for which a technique similar to the examples of FIG. 4A, FIG. 4B, FIG. 4C, and FIG. 4D can be extended to a two-dimensional array application. FIG. 5B shows an illustrative example of acoustic beam directions, the acoustic beams extending at least in part radially in a circular arrangement about a central axis of the two-dimensional array, with respective pulse profile polarities indicated by “+” or “−” symbols. Applications for such an arrangement of radially-extending beams can include a rotating tube inspection system (RTIS). RTIS can include inspection of oblique flaws or notches in all orientations (e.g., from zero to 360 degrees), such as for compliance with a regulatory requirement or standard where such inspection must achieve coverage of all flaw orientations (e.g., not just parallel or transverse to a long axis of a tubular structure). If pulse-echo inspection is used, without contemporaneous firing, numerous directional ultrasonic beams are transmitted sequentially using a linear or matrix array located on an exterior surface of the tubular object under test to cover oblique flaws from zero to 360 degrees. The approach described herein allows multiple beams to be generated contemporaneously, such as enhancing inspection throughput, include suppressing or entirely inhibiting generation of undesired sidelobes. For example, the present technique can be used for contemporaneous firing including inhibiting or suppressing a sidelobe in a normally-incident direction to a tubular object under test.

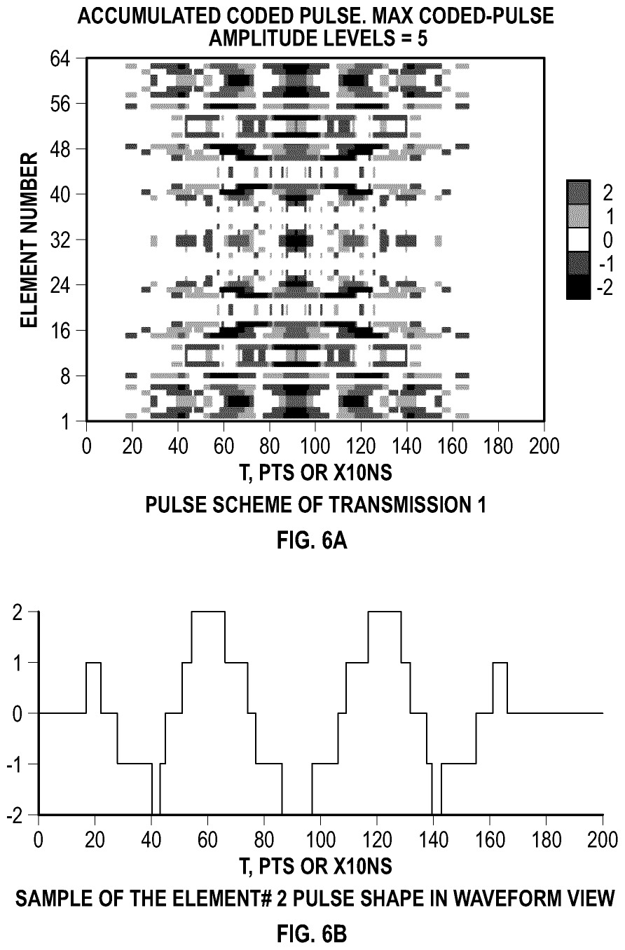

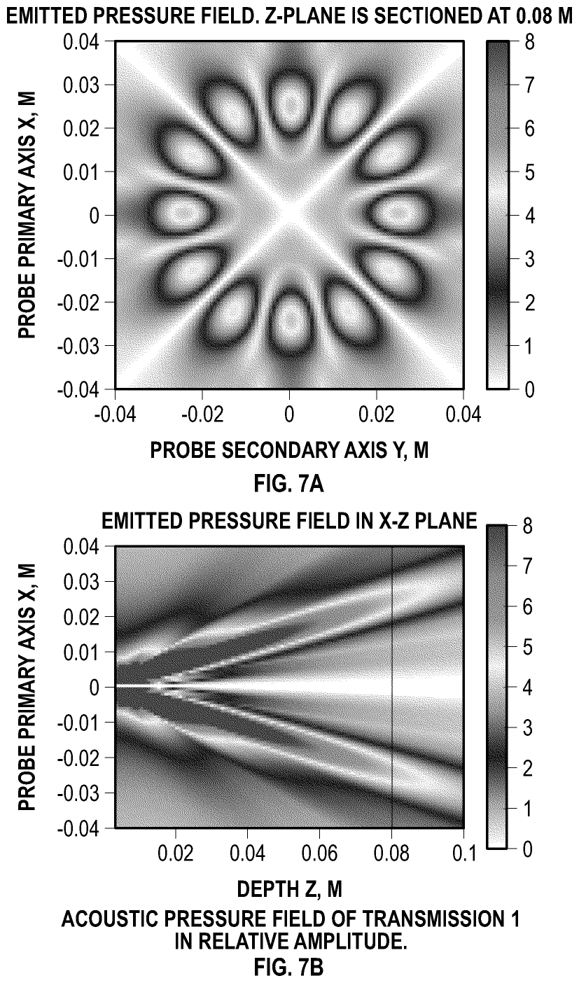

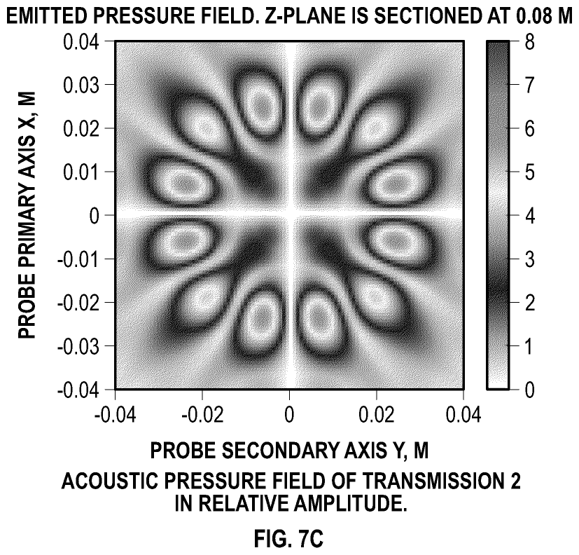

FIG. 6A shows an illustrative example comprising pulse sequences and corresponding amplitudes for each element in a 64-element array, such as a 2D array as shown in FIG. 5A having pulse profiles corresponding to the profile polarities shown illustratively in FIG. 5B and FIG. 6B shows an illustrative example comprising a pulse sequences for an individual transducer element (or transducer aperture), according to the scheme shown in FIG. 6A. FIG. 7A shows an illustrative example comprising an acoustic pressure field in a section of Z-plane (according to the coordinate system shown illustratively in FIG. 5A), established using the pulse sequence of FIG. 6A (e.g., a first transmit set), showing different acoustic beam directions, the acoustic beams extending at least in part radially in a circular arrangement about a central axis of the two-dimensional array. FIG. 7B shows an illustrative example comprising an acoustic pressure field in a section of the X-Z plane (according to the coordinate system shown illustratively in FIG. 5A), showing the different acoustic beam directions of FIG. 7A from another perspective. The pressure fields of FIG. 7A and FIG. 7B can be used for a first acquisition corresponding to a first set of pulse sequences defining a first beam group.

FIG. 7C shows an illustrative example comprising an acoustic pressure field in a section of Z-plane (according to the coordinate system shown illustratively in FIG. 5A), where acoustic beams are established using a different set of transmit sequences (e.g., a second transmit set), such as to establish another set of acoustic beams (e.g., a second beam group) located in the “gaps” between the acoustic beams established using the pulse sequence of FIG. 6A and as shown in FIG. 7A.

As an illustration, the approach shown in FIG. 7A or FIG. 7C (or a combination involving two acquisitions using the field profile of FIG. 7A in a first transmit set and the field profile of FIG. 7C in a second transmit set) can be used for various applications such as in a rotating tube inspection system (RTIS), as mentioned above, for detection of oblique flaws or notches having 0-degree to 360-degree orientations.

As mentioned above, in the absence of the present subject matter, complex drive circuitry or generation of possible unwanted side-lobes (e.g., in a normal direction to the beam) may occur in applications where multiple beam directions are transmitted simultaneously, particularly as frequency is increased. By contrast, using an approach as shown illustratively in FIG. 7A or FIG. 7C (or both in a series of two or more acquisitions), such as having pulse profile polarities arranged as shown illustratively in FIG. 5B, two or more acoustic beams can be provided, oriented in specified directions. Such an approach can be achieved with reduced drive complexity. For example, as shown in FIG. 6A, five amplitude levels can be used, such as plus full unit (+2), half-full-unit (+1), zero (0), minus half-full-unit (−1), and minus full unit (−2). Other beam configurations are possible, and the spatial configurations shown in FIGS. 7A, 7B, and 7C, are merely illustrative. In general, a count of pulse levels (including the zero-amplitude level) can be less than a count of pulses in the sequence. The simulations of FIG. 7A, FIG. 7B, and FIG. 7C were prepared using FIELD II, available from http://field-ii.dk//, Jørgen Arendt Jensen, Denmark.

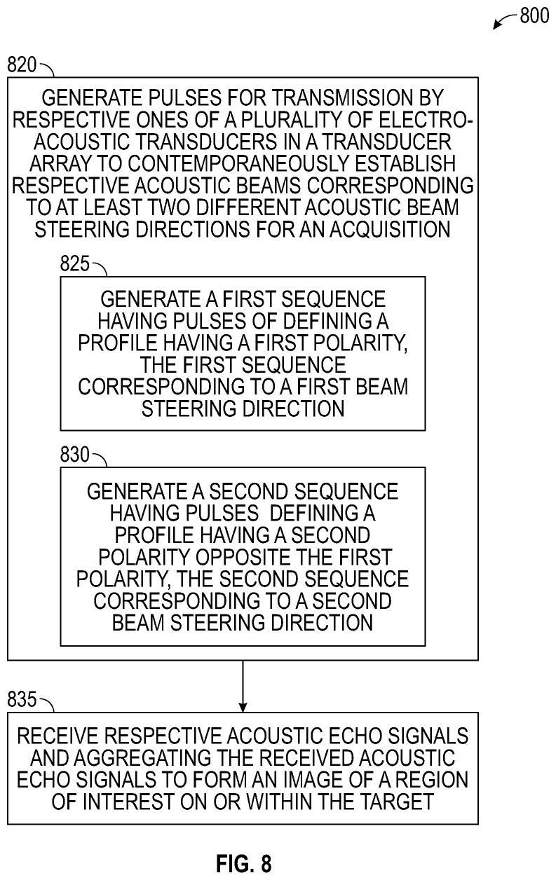

FIG. 8 illustrates generally a technique 800, such as a method for operating an acoustic inspection system, comprising at 820, generating pulses for transmission by respective ones of a plurality of electro-acoustic transducers in a transducer array to contemporaneously establish respective acoustic beams corresponding to at least two different acoustic beam steering directions for an acquisition. At 825, the generating the pulses can include generating a first sequence having pulses of defining a profile having a first polarity, the first sequence corresponding to a first beam steering direction, and at 830, generating a second sequence having pulses defining a profile having a second polarity opposite the first polarity, the second sequence corresponding to a second beam steering direction. At 835, in response to transmission of the pulses, respective acoustic echo signals can be received and aggregated (e.g., coherently summed) to form an image of a region of interest on or within the target.

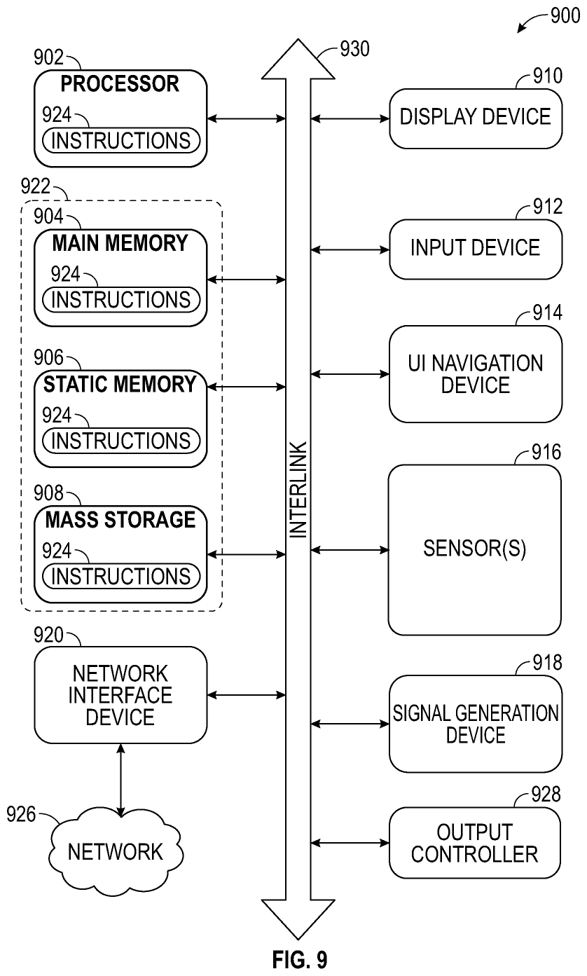

FIG. 9 illustrates a block diagram of an example comprising a machine 900 upon which any one or more of the techniques (e.g., methodologies) discussed herein may be performed. Machine 900 (e.g., computer system) may include a hardware processor 902 (e.g., a central processing unit (CPU), a graphics processing unit (GPU), a hardware processor core, or any combination thereof), a main memory 904 and a static memory 906, connected via an interconnect 930 (e.g., link or bus), as some or all of these components may constitute hardware for systems or related implementations discussed above.

Specific examples of main memory 604 include Random Access Memory (RAM), and semiconductor memory devices, which may include storage locations in semiconductors such as registers. Specific examples of static memory 906 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 900 may further include a display device 910, an input device 912 (e.g., a keyboard), and a user interface (UI) navigation device 914 (e.g., a mouse). In an example, the display device 910, input device 912 and UI navigation device 914 may be a touch-screen display. The machine 900 may include a mass storage device 908 (e.g., drive unit), a signal generation device 918 (e.g., a speaker), a network interface device 920, and one or more sensors 916, such as a global positioning system (GPS) sensor, compass, accelerometer, or some other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 908 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the mass storage device 908 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine readable medium 922 is illustrated as a single medium, the term “machine readable medium” may include a single medium or multiple media (e.g., a centralized or distributed database, or associated caches and servers) configured to store the one or more instructions 924.

A central processing unit (CPU), a graphics processing unit (GPU), a hardware processor core, or any combination thereof), a main memory 904 and a static memory 906, sensors 916, network interface device 920, antennas, a display device 910, an input device 912, a UI navigation device 914, a mass storage device 908, instructions 924, a signal generation device 918, or an output controller 928. The apparatus may be configured to perform one or more of the methods or operations disclosed herein.

The term “machine readable medium” includes, for example, any medium that is capable of storing, encoding, or carrying instructions for execution by the machine 900 and that cause the machine 900 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 924 may be transmitted or received, for example, over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 920 includes one or more physical jacks (e.g., Ethernet, coaxial, or other interconnection) or one or more antennas to access the communications network 926. In an example, the network interface device 920 includes one or more antennas to wirelessly communicate using at least one of single-input multiple-output (SIMO), multiple-input multiple-output (MIMO), or multiple-input single-output (MISO) techniques. In some examples, the network interface device 920 wirelessly communicates using Multiple User MIMO techniques. The term “transmission medium” shall be taken to include any intangible medium that is capable of storing, encoding, or carrying instructions for execution by the machine 900, and includes digital or analog communications signals or other intangible medium to facilitate communication of such software.

### Various Notes

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method for acoustic evaluation of a target using an array of electro-acoustic transducers, the method comprising:
generating pulses for transmission by respective ones of a plurality of electro-acoustic transducers in a transducer array to contemporaneously establish respective acoustic beams corresponding to at least two different acoustic beam steering directions for an acquisition, the pulses comprising at least a first sequence having pulses of defining a profile having a first polarity, the first sequence corresponding to a first beam steering direction, and a second sequence having pulses defining a profile having a second polarity opposite the first polarity, the second sequence corresponding to a second beam steering direction; and
in response to transmission of the pulses, receiving respective acoustic echo signals and aggregating the received acoustic echo signals to form an image of a region of interest on or within the target.

2. The method of claim 1, wherein generating the pulses includes generating respective sequences for different ones of the plurality of electro-acoustic transducers including suppressing generation of pulses for a central element or aperture defined by the transducer array.

3. The method of claim 1, wherein the first sequence and the second sequence define respective pulse sequences for different ones of the plurality of electro-acoustic transducers, the respective pulse sequences comprising a sum of contributions from the first sequence and the second sequence corresponding to a respective one of the plurality of electro-acoustic transducers.

4. The method of claim 1, wherein the array comprises a one-dimensional array.

5. The method of claim 4, wherein the array comprises a linear array.

6. The method of claim 4, wherein an amplitude of a pulse within each respective pulse sequence is at most a single unit-amplitude.

7. The method of claim 1, wherein the array comprises a two-dimensional array.

8. The method of claim 7, wherein generating pulses for transmission by respective ones of the plurality of electro-acoustic transducers in the two-dimensional array comprises contemporaneously establishing respective acoustic beams corresponding to multiple acoustic beam directions for the acquisition, the acoustic beams extending at least in part radially in a semi-circular or circular arrangement about a central axis of the two-dimensional array.

9. The method of claim 8, wherein the first and second sequences correspond to adjacent acoustic beams in the semi-circular or circular arrangement about the central axis of the two-dimensional array.

10. The method of claim 1, wherein any amplitude of a pulse within each respective pulse sequence comprises a half unit-amplitude, a whole unit-amplitude, or zero amplitude.

11. The method of claim 1, wherein amplitudes of respective pulses within each respective pulse sequence are established using a count of levels that are fewer than a count of pulses in the sequence.

12. The method of claim 1, wherein generating the pulses for transmission includes suppressing formation of a sidelobe or beam in a direction normal to a surface of the target.

13. The method of claim 1, wherein the first sequence and the second sequence are included as a first transmit set defining first beam group corresponding to a first acquisition; and wherein the method comprises generating respective sequences comprising a second transmit set defining a different second beam group corresponding to a second acquisition.

14. The method of claim 13, wherein the second beam group defines beam directions located in gaps between respective beam directions of the first beam group.

15. An ultrasonic inspection system for acoustic evaluation of a target, the system comprising:
an analog front end comprising transmit and receive circuitry coupled to a plurality of electro-acoustic transducer elements;
a processor circuit communicatively coupled with the analog front end; and
a memory circuit comprising instructions that, when executed by the processor circuit, cause the system to:
generate pulses for transmission by respective ones of the plurality of electro-acoustic transducers in a transducer array to contemporaneously establish respective acoustic beams corresponding to at least two different acoustic beam steering directions for an acquisition, the pulses comprising at least a first sequence having pulses of defining a profile having a first polarity, the first sequence corresponding to a first beam steering direction, and a second sequence having pulses defining a profile having a second polarity opposite the first polarity, the second sequence corresponding to a second beam steering direction; and
in response to transmission of the pulses, receive respective acoustic echo signals and aggregating the received acoustic echo signals to form an image of a region of interest on or within the target.

16. The ultrasonic inspection system of claim 15, wherein the first sequence and the second sequence define respective pulse sequences for different ones of the plurality of electro-acoustic transducers, the respective pulse sequences comprising a sum of contributions from the first sequence and the second sequence corresponding to a respective one of the plurality of electro-acoustic transducers.

17. The ultrasonic inspection system of claim 15, wherein the plurality of electro-acoustic transducers comprises a one-dimensional array.

18. The ultrasonic inspection system of claim 17, wherein an amplitude of a pulse within each respective pulse sequence is at most a single unit-amplitude.

19. The ultrasonic inspection system of claim 15, wherein the plurality of electro-acoustic transducers comprises a two-dimensional array.

20. The ultrasonic inspection system of claim 19, wherein the instructions to generate pulses for transmission by respective ones of the plurality of electro-acoustic transducers in the two-dimensional array comprise instructions to contemporaneously establishing respective acoustic beams corresponding to multiple acoustic beam directions for the acquisition, the acoustic beams extending at least in part radially in a semi-circular or circular arrangement about a central axis of the two-dimensional array.

21. The ultrasonic inspection system of claim 20, wherein the first and second sequences correspond to adjacent acoustic beams in the semi-circular or circular arrangement about the central axis of the two-dimensional array.

22. The ultrasonic inspection system of claim 15, wherein any amplitude of a pulse within each respective pulse sequence comprises a half unit-amplitude, a whole unit-amplitude, or zero amplitude.

23. The ultrasonic inspection system of claim 15, wherein amplitudes of respective pulses within each respective pulse sequence are established using a count of levels that are fewer than a count of pulses in the sequence.

24. The ultrasonic inspection system of claim 15, wherein the instructions to generate the pulses for transmission include instructions to suppress formation of a sidelobe or beam in a direction normal to a surface of the target.

25. The ultrasonic inspection system of claim 15, wherein the first sequence and the second sequence are included in a first transmit set defining first beam group corresponding to a first acquisition; and wherein the instructions comprise instructions to generate respective sequences comprising a second transmit set defining a different second beam group corresponding to a second acquisition.

26. The ultrasonic inspection system of claim 25, wherein the second beam group defines beam directions located in gaps between respective beam directions of the first beam group.

27. An ultrasonic inspection system for acoustic evaluation of a target, the system comprising:
a means for generating pulses for transmission by respective ones of a plurality of electro-acoustic transducers in a transducer array to contemporaneously establish respective acoustic beams corresponding to at least two different acoustic beam steering directions for an acquisition, the pulses comprising at least a first sequence having pulses of defining a profile having a first polarity, the first sequence corresponding to a first beam steering direction, and a second sequence having pulses defining a profile having a second polarity opposite the first polarity, the second sequence corresponding to a second beam steering direction; and
a means for receiving respective acoustic echo signals in response to transmission of the pulses; and
a means for aggregating the received acoustic echo signals to form an image of a region of interest on or within the target.
